(19) United States
(12) Patent Application Publication
(10) Pub. No.: US 2011/0034182 A1
(43) Pub. Date: Feb. 10, 2011

(54) GEOGRAPHIC MESSAGING USING LOCATION-IDENTIFIED ACCESS POINTS

(75) Inventors: Alfredo C. Issa, Apex, NC (US); Richard J. Walsh, Raleigh, NC (US)

Correspondence Address: WITHROW & TERRANOVA, P.L.L.C., 100 REGENCY FOREST DRIVE, SUITE 160, CARY, NC, 27518, US

(73) Assignee: OTO TECHNOLOGIES, LLC, Raleigh, NC (US)

(21) Appl. No.: 12/535,862

(22) Filed: Aug. 5, 2009

(51) Int. Cl. H04W 64/00; H04W 4/02

(52) U.S. Cl. 455/456.3; 455/466

(57) ABSTRACT

Systems and methods are provided for geographic messaging using a Peer-to-Peer (P2P) network of location-identified access points, such as femtocells. In one embodiment, a femtocell receives a message from an associated mobile device. The message is then routed from the femtocell to one or more other femtocells located within an area of interest of the message via the P2P network. The femtocells located in the area of interest of the message then deliver the message to mobile devices located within coverage areas of the femtocells. In addition, rights management may be performed to control introduction of messages at the femtocells, propagation of messages through the femtocells, and/or delivery of messages by the femtocells.

### FIELD OF THE DISCLOSURE

The present disclosure relates to geographic messaging using a Peer-to-Peer (P2P) network of location-identified access points, such as femtocells.

### BACKGROUND

What is needed is a system and method for providing geographic based messaging. Such a system and method would be beneficial where a user desires to send a message to all users located within a specified geographic area.

### SUMMARY OF THE DETAILED DESCRIPTION

The present disclosure relates to geographic messaging using a Peer-to-Peer (P2P) network of location-identified access points, such as femtocells. In one embodiment, a femtocell receives a message from an associated mobile device. An area of interest for the message is either expressly identified by a user of the mobile device or determined based on one or more criteria such as message type of the message, content type of the content of the message, characteristic (e.g., size) of the message, or the like. The message is then routed from the femtocell to one or more other femtocells located within the area of interest of the message via the P2P network. The femtocells located in the area of interest of the message then deliver the message to mobile devices located within coverage areas of the femtocells. In addition, rights management may be performed to control introduction of messages at the femtocells, propagation of messages through the femtocells, and/or delivery of messages by the femtocells.

Those skilled in the art will appreciate the scope of the present invention and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the invention, and together with the description serve to explain the principles of the invention.

FIG. 1 illustrates a femtocell enabling geographic based messaging according to one embodiment of the present disclosure;

FIG. 2 illustrates a system including a number of femtocells connected via a Peer-to-Peer (P2P) network and enabling geographic based messaging according to one embodiment of the present disclosure;

FIG. 3 illustrates the operation of the system of FIG. 2 according to one embodiment of the present disclosure;

FIG. 4 is a more detailed illustration of the system of FIG. 2 according to one embodiment of the present disclosure in which the P2P network is implemented as a hybrid P2P network;

FIG. 5 illustrates the operation of the system of FIG. 4 according to one embodiment of the present disclosure;

FIG. 6 illustrates the operation of the system of FIG. 4 according to another embodiment of the present disclosure;

FIG. 7 is a more detailed illustration of the system of FIG. 2 according to another embodiment of the present disclosure in which the P2P network is a pure P2P network and messages are routed using location-based routing;

FIG. 8 illustrates the operation of the system of FIG. 2 according to yet another embodiment of the present disclosure in which the femtocells implement a P2P Distributed Hash Table (DHT) for storing and retrieving messages based on location;

FIG. 9 is a block diagram of the femtocell of FIG. 1 according to one embodiment of the present disclosure;

FIG. 10 is a block diagram of the mobile device of FIG. 1 having a cellular interface according to one embodiment of the present disclosure;

FIG. 11 is a block diagram of the mobile device of FIG. 1 having a local wireless network interface according to one embodiment of the present disclosure; and

FIG. 12 is a block diagram of the server of FIG. 4 according to one embodiment of the present disclosure.

### DETAILED DESCRIPTION

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

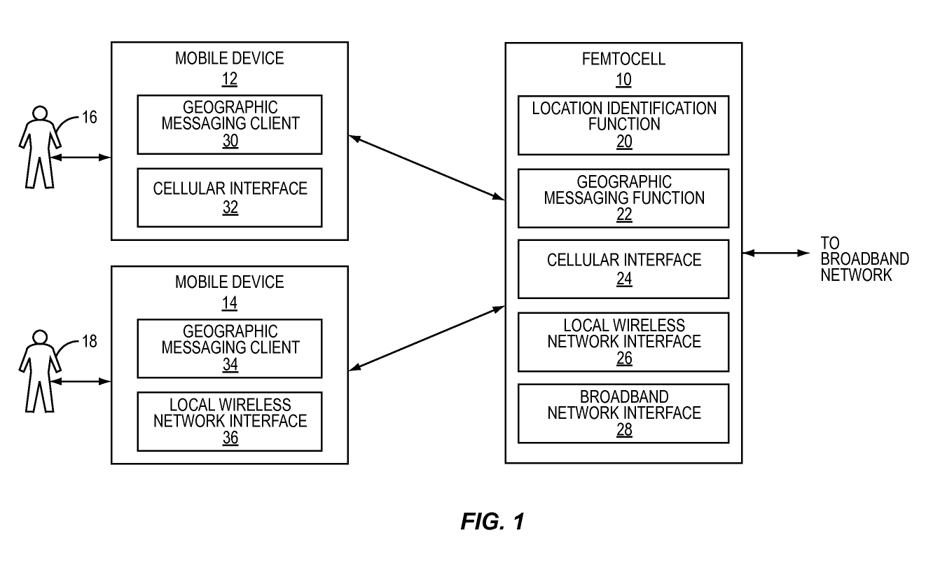

FIG. 1 illustrates a femtocell 10 enabling geographic messaging according to one embodiment of the present disclosure. Note that while this disclosure focuses on femtocells, like the femtocell 10, the concepts described herein may be used to provide geographic based messaging using any type of location-identified access points such as, for example, location-identified femtocells, location-identified Wi-Fi access points, mobile devices operating as access points for nearby devices, or the like. The femtocell 10 operates as a base station for a cellular communications network for a relatively small area, which is typically inside a residential or business environment such as a person's home, a shopping center, or the like. In one embodiment, the femtocell 10 is a physical device similar to wireless access point. In another embodiment, the femtocell 10 is a physical component incorporated into another physical device such as a wireless access point, a router, or the like. As discussed below, the femtocell 10 provides geographic based messaging for mobile devices 12 and 14 located within a coverage area of the femtocell 10. The mobile devices 12 and 14 have associated users 16 and 18, respectively.

The femtocell 10 includes a location identification function 20, a geographic messaging function 22, a cellular interface 24, a local wireless network interface 26, and a broadband network interface 28. The location identification function 20 may be implemented in hardware, software, or a combination thereof. In general, the location identification function 20 either determines a location of the femtocell 10 or enables a user to manually enter a location of the femtocell 10. For example, the location identification function 20 may be a Global Positioning System (GPS) receiver that operates to determine GPS coordinates defining a location of the femtocell 10. The GPS coordinates may be used as the location of the femtocell 10 or may be converted to another format such as, for example, a street address. As another example, the location identification function 20 may be a software application or hardware component that obtains the location of the femtocell 10 from an external source such as, for example, a mobile telecommunications service provider. As yet another example, the location identification function 20 is a software application or feature that enables an owner or operator of the environment in which the femtocell 10 is located or a service provider (e.g., cellular network provider) to manually enter the location of the femtocell 10. Note that the examples given above for the location identification function 20 are for illustrative purposes only and are not intended to be an exhaustive list of implementations of the location identification function 20. One of ordinary skill in the art will recognize that there are numerous ways in which the location of the femtocell 10 may be identified.

The geographic messaging function 22 is preferably, but not necessarily, implemented in software. As discussed below in detail, the geographic messaging function 22 operates to receive messages from the mobile devices 12 and 14 via the cellular interface 24 and the local wireless network interface 26, where the messages have corresponding geographic Areas of Interest (AOIs). From the geographic messaging function 22, the messages are propagated from the femtocell 10 over a Peer-to-Peer (P2P) network of femtocells established over a broadband network to femtocells located in the corresponding geographic AOIs. Note that, in an alternative embodiment, the P2P network of femtocells may be a wireless ad-hoc network formed by the femtocells using associated wireless communication interfaces such as, for example, WiFi interfaces. The femtocells in the corresponding geographic AOIs then deliver the messages to one or more mobile devices in coverage areas of the femtocells. Similarly, the geographic messaging function 22 receives messages from other femtocells connected to the P2P network. If the location of the femtocell 10 is within the AOI of the received messages, the geographic messaging function 22 delivers the messages to one or more mobile devices, such as the mobile devices 12 and 14, within the coverage area of the femtocell 10. In addition, as discussed below, the geographic messaging function 22 may perform rights management operations with respect to introducing new messages at the femtocell 10 from the mobile devices 12 and 14 within the coverage area of the femtocell 10, propagation of messages received from other femtocells connected to the P2P network, and/or delivery of messages received from other femtocells to the mobile devices 12 and 14 within the coverage area of the femtocell 10.

The cellular interface 24 is implemented in hardware or a combination of hardware and software. The cellular interface 24 operates according to a cellular communications standard such as, for example, a 3G cellular communications standard or a 4G cellular communications standard. Exemplary 3G cellular communications standards include, but are not limited to, the Global System for Mobile communications (GSM) standard, the Enhanced Data Rates for GSM Evolution (EDGE) standard, the Universal Mobile Telecommunications System (UMTS) standard, and the Code Division Multiple Access 2000 (CDMA) standard. Exemplary 4G cellular communications standards include, but are not limited to, the Long Term Evolution (LTE) standard and the IEEE 802.16m standard. The cellular interface 24 operates to provide communication between the femtocell 10 and mobile devices within the coverage area of the femtocell 10 that are also equipped with cellular interfaces.

The local wireless network interface 26 is implemented in hardware or a combination of hardware and software. The local wireless network interface 26 operates according to a local wireless communication standard such as, for example, one of the suite of IEEE 802.11 standards. The local wireless network interface 26 operates to provide communication between the femtocell 10 and mobile devices within the coverage area of the femtocell 10 that are also equipped with local wireless network interfaces. It should be noted that the local wireless network interface 26 is an optional component of the femtocell 10.

The broadband network interface 28 is implemented in hardware or a combination of hardware and software. The broadband network interface 28 may be, for example, an Ethernet connection to a cable (e.g., Data Over Cable Service Interface Specification (DOCSIS)) or Digital Subscriber Line (DSL) modem provided by an Internet Service Provider (ISP). As will be appreciated by one of ordinary skill in the art, the femtocell 10 uses the broadband network interface 28 for normal femtocell operation within the cellular network. In addition, the femtocell 10 uses the broadband network interface 28 to communicate with the P2P network of femtocells for geographic messaging as described herein. Again, note that, in an alternative embodiment, the P2P network of femtocells may be a wireless ad-hoc network formed by the femtocells using associated wireless communication interfaces such as, for example, WiFi interfaces

In this embodiment, the mobile device 12 is a device such as, for example, a mobile phone, an e-reader (e.g., an Amazon Kindle), a wireless handheld gaming device, or the like. However, the mobile device 12 may be any device equipped with a cellular interface capable of communicating with the femtocell 10. The mobile device 12 includes a geographic messaging client 30 and a cellular interface 32. The geographic messaging client 30 is preferably, but not necessarily, implemented in software. In general, the geographic messaging client 30 enables the user 16 to generate a message having a geographic AOI. While the discussion herein focuses on a message having a single geographic AOI, the present disclosure is not limited thereto. A message may have one or more geographic AOIs. Note that, in an alternative embodiment, the geographic messaging client 30 automatically generates the message having a geographic AOI. For example, if the mobile device 12 hosts a gaming application, the geographic messaging client 30 may automatically generate a message when the user 16 initiates or starts-up the gaming application. Once the message is generated, the geographic messaging client 30 sends the message to the femtocell 10, where the message is propagated to femtocells located within the geographic AOI of the message from the geographic messaging function 22 of the femtocell 10 via the P2P network of femtocells. In addition, the geographic messaging client 30 receives messages from the femtocell 10 and presents the messages to the user 16. The cellular interface 32 is implemented in hardware or a combination of hardware and software. The cellular interface 32 operates according to a cellular communications standard such as, for example, a 3G cellular communications standard or a 4G cellular communications standard. The cellular interface 32 operates to provide communication between the mobile device 12 and the femtocell 10.

The mobile device 14 is a device such as, for example, portable media player such as an Apple iPod Touch, a laptop computer, a Personal Digital Assistant (PDA), or the like. However, the mobile device 14 may be any device equipped with a local wireless network interface capable of communicating with the femtocell 10. The mobile device 14 includes a geographic messaging client 34 and a local wireless network interface 36. The geographic messaging client 34 is preferably, but not necessarily, implemented in software. In general, like the geographic messaging client 30 of the mobile device 12, the geographic messaging client 34 enables the user 18 to generate a message having a geographic AOI. The geographic messaging client 34 sends the message to the femtocell 10, where the message is propagated to femtocells located within the geographic AOI of the message from the geographic messaging function 22 of the femtocell 10 via the P2P network of femtocells. In addition, the geographic messaging client 34 receives messages from the femtocell 10 and presents the messages to the user 18. The local wireless network interface 36 is implemented in hardware or a combination of hardware and software. The local wireless network interface 36 operates according to a local wireless communication standard such as, for example, one of the suite of IEEE 802.11 standards. The local wireless network interface 36 operates to provide communication between the mobile device 14 and the femtocell 10.

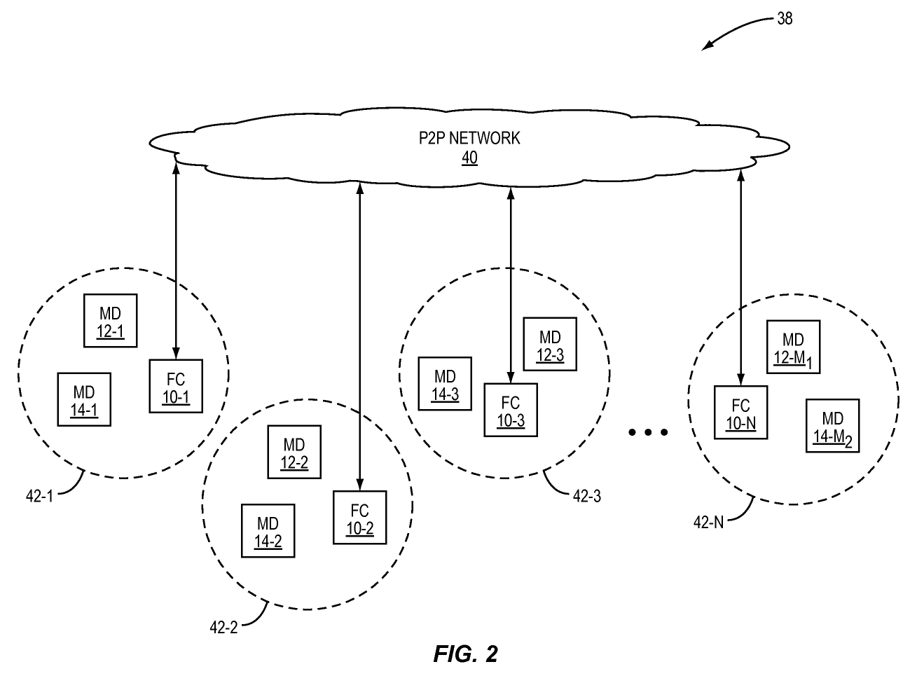

FIG. 2 illustrates a system 38 enabling geographic messaging using location-identified femtocells 10-1 through 10-N connected via a P2P network 40 according to one embodiment of the present disclosure. The femtocells 10-1 through 10-N have corresponding coverage areas 42-1 through 42-N. In this exemplary embodiment, mobile devices 12-1 through 12-M₁ are located within the coverage areas 42-1 through 42-N of the femtocells 10-1 through 10-N as illustrated. Likewise, in this exemplary embodiment, mobile devices 14-1 through 14-M₂ are located within the coverage areas 42-1 through 42-N of the femtocells 10-1 through 10-N as illustrated. The P2P network 40 is an overlay network connecting the femtocells 10-1 through 10-N formed over a Wide Area Network (WAN) such as, for example, a distributed public network such as the Internet.

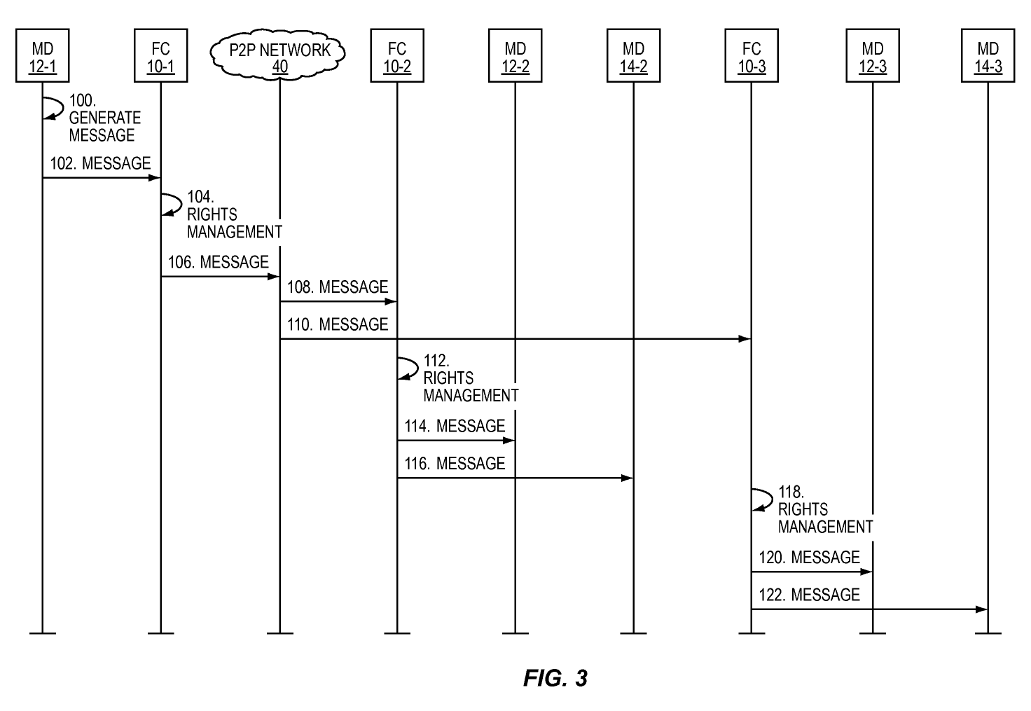

FIG. 3 illustrates the operation of the system 38 of FIG. 2 according to one embodiment of the present disclosure. First, the mobile device 12-1 generates a message having a geographic AOI (step 100). More specifically, the user of the mobile device 12-1 interacts with the geographic messaging client 30 of the mobile device 12-1 to create content for the message. The content for the message may be text, audio, video, image(s), or the like, or any combination thereof. In one embodiment, the geographic messaging client 30 of the mobile device 12-1 enables the user to select a geographic AOI for the message from a predefined list of geographic AOIs. The predefined list of geographic AOIs may be predefined by a provider of the geographic messaging client 30 or a service provider associated with the femtocells 10-1 through 10-N. The predefined list of geographic AOIs may include, for example, neighborhoods or communities, towns or cities, counties, state regions (i.e., regions within a state), states, country regions (i.e., regions within a country), countries, geographic areas defined by zip codes, geographic areas defined by area codes for telephone service, school districts, establishment names (e.g., NC State University, Wal-mart, or the like), a predefined distance from the location of the femtocell 10-1 (e.g., one mile from the femtocell 10-1), or the like. In another embodiment, the geographic messaging client 30 of the mobile device 12-1 enables the user to arbitrarily define the geographic AOI for the message. For example, the geographic messaging client 30 may enable the user to select an area on a map, select an arbitrary distance from the location of the femtocell 10-1, or the like. Further, when defining an arbitrary AOI, the arbitrary selected geographic region may be combined with one or more additional criteria to define the AOI. For example, the user may define the AOI as all Home Depot stores within 10 miles from the location of the femtocell 10-1.

In another embodiment, rather than selecting or defining the geographic AOI for the message, one or more criteria such as message type of the message, content type of the content of the message, characteristic (e.g., size) of the message, or the like may be used to automatically determine the geographic AOI of the message. For example, the user of the mobile device 12-1 may select a message type for the message from a predefined list of message types where each message type in the predefined list of message types has a corresponding predefined geographic AOI. For example, the predefined list of message types may include a “for sale” message type that users may use to send messages related to items of theirs that are for sale where the “for sale” message type has a corresponding predefined geographic AOI, which may be, for example, the current city or town in which the femtocell 10-1 is located. In a similar manner, the predefined list of message types may include any number of message types having corresponding geographic AOIs. Similarly, geographic AOIs may additionally or alternatively be defined for a number of message content types and/or message characteristics such as, for example, message size or quality of audio or video content forming the message, or the like.

In addition to enabling the user to define the content and geographic AOI of the message, the geographic messaging client 30 may further enable the user to narrow the scope of the message by defining one or more additional criteria for defining intended recipients or recipient devices of the message. The one or more additional criteria may include one or more criteria specifying a device type for intended recipients, one or more user-based criteria, one or more criteria identifying one or more specific mobile devices to which the message is to be delivered, one or more criteria specifying that the message is only to be delivered to mobile devices bound to femtocells as their home femtocells, one or more criteria defining a time period for the message, and/or one or more criteria based on femtocell attributes.

With respect to device type, as an example, the one or more additional criteria for the message may specify that the message is to be delivered only to certain types of mobile devices within the geographic AOI of the message. For instance, the additional criteria may specify that the message is only to be delivered to Apple iPhones or delivered only to devices having video playback capabilities. With respect to user-based criteria, the one or more additional criteria for the message may specify that the message is only to be delivered to mobile devices of users satisfying one or more user-based criteria located within the geographic AOI of the message. The user-based criteria may be based on demographics. With respect to criteria specifying specific mobile devices, the one or more additional criteria for the message may specify one or more specific mobile devices to which the message is to be delivered. These mobile devices may be identified using any suitable identifier such as, but not limited to, mobile telephone number. In this case, unlike in traditional cellular telecommunications systems, the message will be delivered to femtocells in the geographic AOI of the message and then delivered to the specified mobile devices only when those mobile devices enter the coverage area of one of the femtocells in the geographic AOI of the message. With respect to mobile devices bound to the femtocells, the one or more additional criteria for the message may specify that the message is to be delivered only to mobile devices bound to the femtocells in the geographic AOI of the message as their home femtocells.

With respect to a time period for the message, the one or more additional criteria for the message may specify a time during which the message is valid and is to be delivered to mobile devices within the geographic AOI of the message. With respect to femtocell attributes, the one or more additional criteria for the message may specify that the message is to be delivered only to femtocells within the geographic AOI of the message that have one or more defined femtocell attributes. For example, the one or more additional criteria for the message may specify that the message is only to be delivered to femtocells manufactured by a particular manufacturer, femtocells of a particular model, femtocells satisfying one or more specified capability related criteria (e.g., greater than a defined threshold of available storage space), or the like. While the discussion above states that the one or more additional criteria for the message are defined by the user of the mobile device 12-1, it should be appreciated that some of these additional criteria may alternatively be predefined by the manufacturer of the femtocell 10-1, the provider of the geographic messaging client 30, or the cellular service provider associated with the femtocells 10-1 through 10-N.

Once the message is generated, the mobile device 12-1 sends the message to the femtocell 10-1 (step 102). Note that, in embodiments where the user does not or has not defined the geographic AOI for the message, the geographic AOI of the message is determined based on one or more criteria such as message type, message content type, characteristic of the message or content of the message, or the like. Upon receiving the message, the femtocell 10-1 performs a rights management process to determine whether to permit the message to be introduced at the femtocell 10-1 (step 104). The rights management process is optional. The rights management process may be performed, or partially performed, prior to generation of the message at the mobile device 12-1 and receipt of the message at the femtocell 10-1. The rights management process is performed using one or more rights management rules. The rights management rules may be based on one or more factors such as, but not limited to, license fee payment by the user of the mobile device 12-1, location, message introduction frequency, message type, message size, message content type, and/or social network relationships.

With respect to license fee payment, the user of the mobile device 12-1 may be permitted to introduce messages at the femtocell 10-1 only if the user has paid a license fee. Note that the license fee may be required for all message types or only particular message types. For example, the license fee may be required for non-emergency message types (e.g., “for sale”) but may not be required for emergency message types (e.g., “AMBER Alert”). With respect to location, the user of the mobile device 12-1 may be permitted to introduce messages at femtocells within a defined geographic area. For example, the user of the mobile device 12-1 may have a home femtocell and be permitted to introduce messages at femtocells within a defined distance from his home femtocell. The home femtocell is a femtocell that has been associated with the mobile device 12-1 as the home femtocell of the mobile device 12-1. Preferably, a femtocell located in the home or place of business of the user of the mobile device 12-1 is the home femtocell of the mobile device 12-1.

With respect to message introduction frequency, the user of the mobile device 12-1 may be limited with respect to the frequency at which he can introduce messages. For example, the user may be permitted to introduce ten messages per day. Further, the limit placed on the message introduction frequency of the user may vary depending on location. For example, the user may be enabled to introduce 25 messages per day at the home femtocell of the user, five messages per day at femtocells located within a defined distance from the home femtocell of the user, and one message per day at all other femtocells. With respect to message type, the user of the mobile device 12-1 may have different permissions for introducing messages based on message type. For example, as discussed above, the user of the mobile device 12-1 may be permitted to introduce emergency message types at any femtocell but have limitations placed on his ability to introduce non-emergency message types.

With respect to message size, a limit may be placed on permissible data size of messages introduced at the femtocell 10-1. For example, a maximum data size may be defined such that messages having sizes less than the maximum data size are allowed and messages having sizes greater than the maximum data size are denied. With respect to message content types, introduction of messages at the femtocell 10-1 may be limited to defined types of message content. For example, the femtocell 10-1 may deny introduction of messages including video content.

With respect to social network relationships, the rights of the user to introduce messages may depend on a relationship in a social network between himself and a user for which the femtocell 10-1 is identified as the home femtocell (e.g., owner of the femtocell 10-1 or owner of premises at which the femtocell 10-1 is located). The social network relationship may be determined by the femtocell 10-1 by querying a social network service such as, for example, using usernames or other credentials of the two users. The rights of the user of the mobile device 12-1 may depend on whether he has a relationship to the user for which the femtocell is a home femtocell and/or a degree of relationship (i.e., one degree of separation, two degrees of separation, etc.) between the user of the mobile device 12-1 and the user for which the femtocell 10-1 is a home femtocell. As an example, the user of the mobile device 12-1 may have rights to introduce messages at femtocells of other users that are a direct friend of the user of the mobile device 12-1 in a social network (i.e., one degree of separation) or are once removed from the user of the mobile device 12-1 in a social network (i.e., two degrees of separation). Similarly, the rights of the user to introduce messages may depend on social network relationships between the user and other users in the coverage area 42-1 of the femtocell 10-1.

Still further, with respect to rights management, the femtocell 10-1 may provide multiple access channels, each having a different level of access or quality. For example, the femtocell 10-1 may provide a public channel and one or more private channels. The public channel may be accessible to all mobile devices, or all users, located in the coverage area 42-1 of the femtocell 10-1 but have restricted access rights (e.g., limitations on the message introduction frequency, message type, message content type, message size, or the like). The one or more private channels may require authentication via open ID or some other secure mechanism but provide greater access (e.g., no or less strict limitations on message introduction).

If the user of the mobile device 12-1 is not permitted to introduce the message at the femtocell 10-1, the geographic messaging function 22 of the femtocell 10-1 may provide a corresponding response to the mobile device 12-1. However, in this embodiment, the user of the mobile device 12-1 is permitted to introduce the message at the femtocell 10-1. As such, the geographic messaging function 22 of the femtocell 10-1 sends the message to the P2P network 40 (step 106). The message is propagated or otherwise routed through the P2P network 40 to femtocells located within the geographic AOI of the message, which in this example are femtocells 10-2 and 10-3 (steps 108 and 110). As discussed below in detail, the manner in which the message is propagated or otherwise routed through the P2P network 40 depends on the particular embodiment.

In this embodiment, upon receiving the message, the femtocell 10-2, and in particular the geographic messaging function 22 of the femtocell 10-2, performs a rights management process to determine whether to deliver the message to mobile devices, such as the mobile devices 12-2 and 14-2, located within the coverage area 42-2 of the femtocell 10-2 (step 112). The rights management process is optional. The rights management process is performed using one or more rules based on factors such as, but not limited to, location, message size, message type, message content type, and/or social network relationship. With respect to location, the femtocell 10-2 may permit only messages that originate from another femtocell within a defined distance from the femtocell 10-2, deny messages that originate from femtocells in one or more defined areas, or the like. With respect to message size, the femtocell 10-2 may allow messages having a data size less than a predefined threshold or deny messages having a data size greater than a predefined threshold. With respect to message type, the femtocell 10-2 may permit one or more defined messages types or deny one or more defined messages types. With respect to content type, the femtocell 10-2 may allow messages having one or more message defined content types or deny messages having one or more defined message content types. For example, the femtocell 10-2 may deny messages having video content. With respect to social network relationships, the femtocell 10-2 may allow messages originating from users that are within a defined number of degrees of separation in a social network from users of one or more of the mobile devices 12-2 and 14-2 located within the coverage area 42-2 of the femtocell 10-2. As another example, the femtocell 10-2 may allow messages originating from users that are within a defined number of degrees of separation in a social network from one or more users bound to the femtocell 10-2 as their home femtocell.

Using the rights management process, the geographic messaging function 22 of the femtocell 10-2 either denies and therefore discards the message or permits the message. In this example, the message is permitted, and as such, the geographic messaging function 22 of the femtocell 10-2 delivers the message to mobile devices 12-2 and 14-2 located within the coverage area 42-2 of the femtocell 10-2 (steps 114 and 116). The message may be delivered immediately, or at least substantially immediately, upon receipt by the mobile devices 12-2 and 14-2 located within the coverage area 42-2 of the femtocell 10-2 and/or cached at the femtocell 10-2 for subsequent delivery to mobile devices that enter the coverage area 42-2 of the femtocell 10-2. Upon delivery of the message to the mobile devices 12-2 and 14-2, the geographic messaging clients 30 and 34 of the mobile devices 12-2 and 14-2, respectively, notify their users of the message and present the message to their users.

The femtocell 10-2 may be configured to provide the message to all mobile devices, such as the mobile devices 12-2 and 14-2, located within the coverage area 42-2 of the femtocell 10-2 or only certain mobile devices located within the coverage area 42-2 of the femtocell 10-2. As a first example, rather than providing the message to all mobile devices, the femtocell 10-2 may be configured to provide the message only to certain types of mobile devices within the coverage area 42-2 of the femtocell 10-2. For instance, the femtocell 10-2 may be configured to provide the message to Apple iPhones or mobile devices having video playback capabilities. As a second example, the femtocell 10-2 may be configured to provide the message to mobile devices of users satisfying one or more user-based criteria. The user-based criteria may be based on demographics. As a third example, the femtocell 10-2 may be configured to provide the message to only one or more predefined mobile devices such as, for example, the mobile device having a particular cellular telephone number. In this case, the message will be delivered to femtocells in the geographic AOI of the message and then delivered to the mobile device only when the mobile device enters the coverage area of one of the femtocells in the geographic AOI of the message. As a final example, the femtocell 10-2 may be configured to provide the message only to mobile devices bound to the femtocell 10-2 as their home femtocell.

Note that the exemplary configuration of the femtocell 10-2 discussed above for limiting the delivery of the message are configurations of the femtocell 10-2. These configurations are to be distinguished from one or more additional criteria defined for the message that limit the scope of the message as discussed above with respect to the generation of the message at the mobile device 12-1. However, if the message has one or more criteria that limit the scope of the message, the femtocell 10-2 delivers the message according to those additional criteria. These additional criteria may be used in addition to or as an alternative to the configurations of the femtocell 10-2 that limit the delivery of the message.

As discussed above, the additional criteria for the message may include one or more criteria specifying a device type for intended recipients, one or more user-based criteria, one or more criteria identifying one or more specific mobile devices to which the message is to be delivered, one or more criteria specifying that the message is only to be delivered to mobile devices bound to femtocells as their home femtocells, one or more criteria defining a time period for the message, and/or one or more criteria based on femtocell attributes. If the message includes additional criteria specifying a device type for intended recipients, the geographic messaging function 22 delivers the message to the mobile devices 12-2 and 14-2 only if the mobile devices 12-2 and 14-2 are of the specified type. If the message includes one or more additional user-based criteria, the geographic messaging function 22 delivers the message to the mobile devices 12-2 and 14-2 only if the users of the mobile devices 12-2 and 14-2 satisfy the user-based criteria. If the message includes one or more additional criteria specifying specific mobile devices to which the message is to be delivered, the geographic messaging function 22 delivers the message to each of the mobile devices 12-2 and 14-2 only if it is one of the specified mobile devices to receive the message. If the message includes one or more additional criteria specifying that the message is to be delivered to mobile devices bound to the femtocell as their home femtocell, the geographic messaging function 22 delivers the message to the mobile devices 12-2 and 14-2 only if the mobile devices 12-2 and 14-2 are bound to the femtocell 10-2 as their home femtocell.

If the message includes additional criteria specifying a time period for the message, the geographic messaging function 22 delivers the message only during the specified time period. Note that, if the time period extends beyond the current time (e.g., the message is valid for the next 24 hours), the femtocell 10-2 stores the message and delivers the message to mobile devices that enter the coverage area 42-2 of the femtocell 10-2 for the duration of the time period for the message. Further, if the time period for the message has not yet begun, the femtocell 10-2 stores the message for future delivery during the time period. If the message includes additional criteria specifying femtocell attributes, the geographic messaging function 22 delivers the message only if the femtocell 10-2 satisfies the specified femtocell attributes. Note that, for some propagation schemes, the message may not be propagated to the femtocell 10-2 if the femtocell 10-2 does not satisfy the femtocell attributes for the message.

Like the femtocell 10-2, in this embodiment, the femtocell 10-3, and particularly the geographic messaging function 22 of the femtocell 10-3, performs a rights management process upon receipt of the message (step 118). Again, the rights management process is optional. Assuming that the message is permitted, the geographic messaging function 22 of the femtocell 10-3 sends the message to the mobile devices 12-3 and 14-3 located within the coverage area 42-3 of the femtocell 10-3 (steps 120 and 122). As discussed above, the message may be delivered immediately, or at least substantially immediately, upon receipt by the mobile devices 12-3 and 14-3 located within the coverage area 42-3 of the femtocell 10-3 and/or cached at the femtocell 10-3 for subsequent delivery to mobile devices that enter the coverage area 42-3 of the femtocell 10-3. Also, as discussed above, prior to delivering the message, the geographic messaging function 22 of the femtocell 10-3 considers any additional criteria for the message that narrow the scope of the message.

While not illustrated in FIG. 3, the users of the mobile devices 12-2, 14-2,12-3, and 14-3 that received the message may be enabled to respond to the message. Preferably, such a response message is handled in the same manner as if the response message were any other message introduced at the femtocells 10-2 and 10-3. Alternatively, the response message may be delivered directly to the mobile device 12-1 using traditional messaging. Further, once a user responds to the message, the message may be rescinded such that the message is not subsequently delivered to any other user.

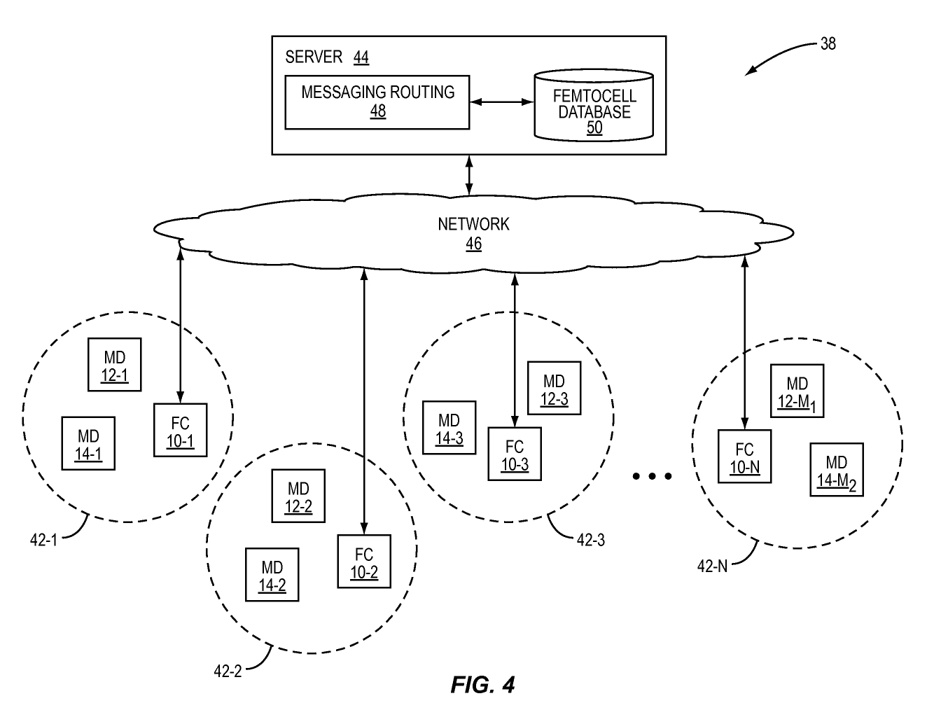

FIG. 4 illustrates the system 38 of FIG. 2 according to one embodiment of the present disclosure. Specifically, in this embodiment, a hybrid P2P scheme is utilized. As such, in this embodiment, the system 38 includes a central server 44 connected to the femtocells 10-1 through 10-N via a network 46. The network 46 may be a distributed public network such as the Internet. However, the network 46 is not limited thereto. The central server 44 is implemented as a physical server or a number of physical servers operating in a collaborative manner for load-sharing and/or redundancy. The server 44 includes a message routing function 48 and a femtocell database 50. The message routing function 48 is preferably, but not necessarily, implemented in software. As discussed below, the message routing function 48 operates to route messages according to their geographic AOIs. The femtocell database 50 stores information regarding each of the femtocells 10-1 through 10-N including, but not limited to, the locations of the femtocells 10-1 through 10-N.

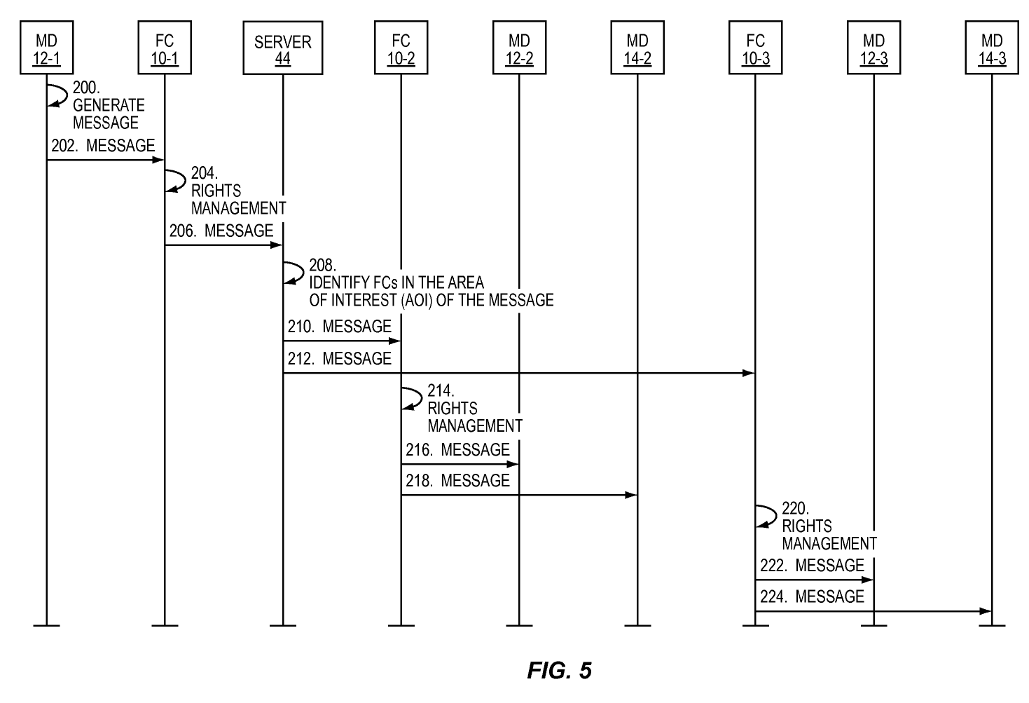

FIG. 5 illustrates the operation of the system 38 of FIG. 4 according to one embodiment of the present disclosure. In this embodiment, the mobile device 12-1 generates a message having a geographic AOI, as described above (step 200). Again, the message includes message content and, optionally, one or more additional criteria narrowing a scope of the message. The geographic AOI for the message may be directly selected or otherwise defined by the user of the mobile device 12-1 or determined based on one or more criteria related to the message or content of the message, as discussed above. Once the message is generated, the mobile device 12-1 sends the message to the femtocell 10-1 (step 202). In this embodiment, upon receiving the message, the femtocell 10-1 performs a rights management process to determine whether to permit the message to be introduced at the femtocell 10-1 (step 204). Again, the rights management process is optional. Note that this rights management process may be performed, or partially performed, prior to generation of the message at the mobile device 12-1 and receipt of the message at the femtocell 10-1. As described above, the rights management process is performed using one or more rights management rules based on factors such as, but not limited to, license fee payment by the user of the mobile device 12-1, location, message introduction frequency, message type, message size, message content type, and/or social network relationships.

If the user of the mobile device 12-1 is not permitted to introduce the message at the femtocell 10-1, the geographic messaging function 22 of the femtocell 10-1 may provide a corresponding response to the mobile device 12-1. However, in this embodiment, the user of the mobile device 12-1 is permitted to introduce the message at the femtocell 10-1. As such, the geographic messaging function 22 of the femtocell 10-1 sends the message to the central server 44 via the network 46 (step 206). The message includes the content of the message and any additional criteria defined to limit the scope of the message. The message also includes the geographic AOI of the message. Alternatively, the message may include the message type of the message, which may be used by the message routing function 48 of the central server 44 to determine the geographic AOI of the message. Note that the message routing function 48 may use metadata regarding the message such as message size, message type, or message content type and/or the content of the message to determine whether the message is allowed. For example, if the message routing function 48 determines that the message is spam, the message routing function 48 may deny propagation of the message.

Upon receiving the message, the central server 44, and particularly the message routing function 48, identifies femtocells located within the geographic AOI of the message (step 208). More specifically, the femtocell database 50 preferably stores the locations of the femtocells 10-1 through 10-N. Note that, in one embodiment, the femtocells 10-1 through 10-N report their locations to the central server 44 automatically or upon request. As such, the message routing function 48 queries the femtocell database 50 to determine which of the femtocells 10-1 through 10-N are located within the geographic AOI of the message. In this example, the femtocells 10-2 and 10-3 are located within the geographic AOI of the message. As such, the message routing function 48 sends the message to the femtocells 10-2 and 10-3 via the network 46 (step 210 and 212). It should be noted that, in some embodiments, the message routing function 48 may modify the message before sending the message to at least some of the identified femtocells 10-2 and 10-3. For example, if the message includes video content, the message routing function 48 may reduce the quality of the video content of the message to be sent to all of the identified femtocells 10-2 and 10-3 to, for example, reduce bandwidth requirements for delivery of the message, adjust the quality of the video content based on the capabilities of the femtocells 10-2 and 10-3, or the like.

From this point, the operation of the system 38 is the same as that described above with respect to FIG. 3. Specifically, in this embodiment, upon receiving the message, the femtocell 10-2, and in particular the geographic messaging function 22 of the femtocell 10-2, performs a rights management process to determine whether to deliver the message to mobile devices, such as the mobile devices 12-2 and 14-2, located within the coverage area 42-2 of the femtocell 10-2 (step 214). Again, the rights management process is optional. Using the rights management process, the geographic messaging function 22 of the femtocell 10-2 either denies and therefore discards the message or permits the message. In this example, the message is permitted, and as such, the geographic messaging function 22 of the femtocell 10-2 delivers the message to mobile devices 12-2 and 14-2 located within the coverage area 42-2 of the femtocell 10-2 (steps 216 and 218). As described above, the message may be delivered immediately, or at least substantially immediately, upon receipt by the mobile devices 12-2 and 14-2 located within the coverage area 42-2 of the femtocell 10-2 and/or cached at the femtocell 10-2 for subsequent delivery to mobile devices that enter the coverage area 42-2 of the femtocell 10-2. Upon delivery of the message to the mobile devices 12-2 and 14-2, the geographic messaging clients 30 and 34 of the mobile devices 12-2 and 14-2, respectively, notify their users of the message and present the message to their users.

As described above, the femtocell 10-2 may be configured to provide the message to all mobile devices, such as the mobile devices 12-2 and 14-2, located within the coverage area 42-2 of the femtocell 10-2 or only certain mobile devices located within the coverage area 42-2 of the femtocell 10-2. In addition or alternatively, if additional criteria are defined to limit the scope of the message, the femtocell 10-2 applies those criteria when delivering the message.

Like the femtocell 10-2, in this embodiment, the femtocell 10-3, and particularly the geographic messaging function 22 of the femtocell 10-3 performs a rights management process upon receipt of the message (step 220). Assuming that the message is permitted, the geographic messaging function 22 of the femtocell 10-3 sends the message to the mobile devices 12-3 and 14-3 located within the coverage area 42-3 of the femtocell 10-3 (steps 222 and 224). Again, as discussed above, the message may be delivered immediately, or at least substantially immediately, upon receipt to the mobile devices 12-3 and 14-3 located within the coverage area 42-3 of the femtocell 10-3 and/or cached at the femtocell 10-3 for subsequent delivery to mobile devices that enter the coverage area 42-3 of the femtocell 10-3. Also, as discussed above, prior to delivering the message, the geographic messaging function 22 of the femtocell 10-3 considers any additional criteria for the message that narrow the scope of the message.

While not illustrated in FIG. 5, the users of the mobile devices 12-2, 14-2,12-3, and 14-3 that received the message may be enabled to respond to the message. Preferably, such a response message is handled in the same manner as if the response message were any other message introduced at the femtocells 10-2 and 10-3. Alternatively, the response message may be delivered directly to the mobile device 12-1 using traditional messaging. Further, once a user responds to the message, the message may be rescinded such that the message is not subsequently delivered to any other user. In a similar manner, a report may be returned to the user of the mobile device 12-1 (i.e., the originator of the message) regarding distribution of the message. The report may include statistics such as the number of users to which the message has been propagated, number and/or locations of users that have expressed an interest in the message by reading or otherwise consuming the message, or the like.

It should be noted that the rights management process performed by the femtocell 10-1 with respect to introduction of the message from the mobile device 12-1 and/or the rights management processes preformed by the femtocells 10-2 and 10-3 with respect to delivery of the message may be at least partially performed by the message routing function 48 of the central server 44. For instance, the message routing function 48, rather than the geographic messaging function 22 of the femtocell 10-1, may determine whether the mobile device 12-1 has the rights to introduce the message at the femtocell 10-1. Any information needed to perform the rights management process may be obtained from appropriate sources and stored in the femtocell database 50 or similar data structure. Similarly, when identifying femtocells to which to send the message, the message routing function 48 of the central server 44 may perform the rights management processes described above with respect to the femtocells 10-2 and 10-3 using rights management rules based on location, message size, message type, message content type, and/or social network relationship. Likewise, when identifying the femtocells to which to send the message, the message routing function 48 may consider additional criteria defined for the message such as, for example, required femtocell attributes.

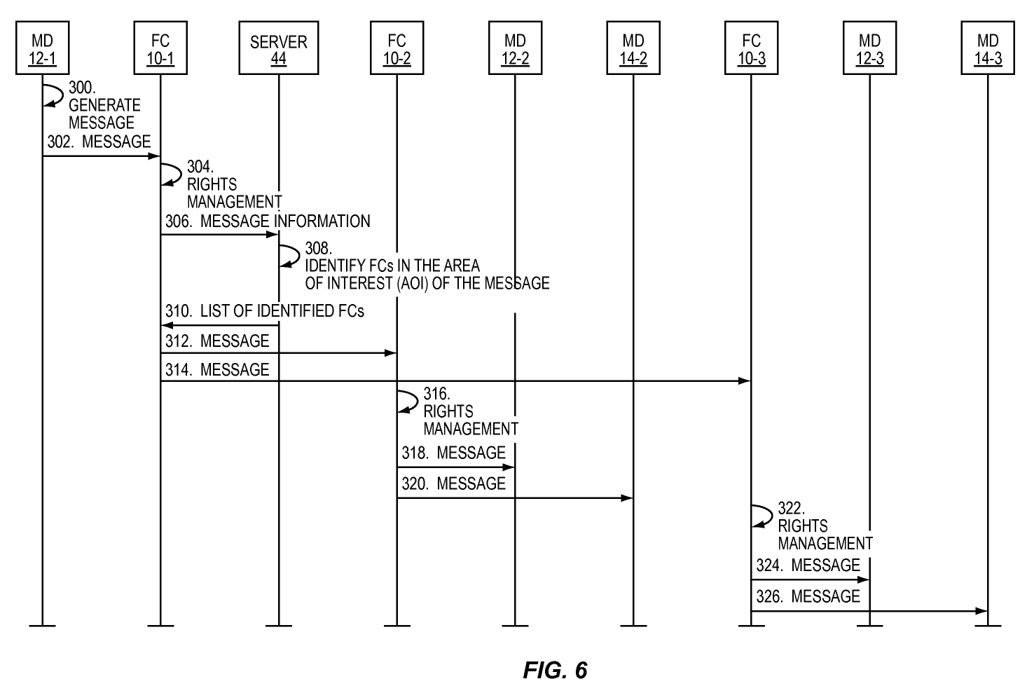

FIG. 6 illustrates the operation of the system 38 of FIG. 4 according to another embodiment of the present disclosure. FIG. 6 is substantially the same as FIG. 5. However, in this embodiment, rather than sending the message to the femtocells 10-2 and 10-3 in the geographic AOI of the message, the message routing function 48 of the central server 44 enables the femtocell 10-1 to send the message directly to the femtocells in the geographic AOI of the message. More specifically, as described above, the mobile device 12-1 generates a message having a geographic AOI, as described above (step 300). Once the message is generated, the mobile device 12-1 sends the message to the femtocell 10-1 (step 302). In this embodiment, upon receiving the message, the femtocell 10-1 performs a rights management process to determine whether to permit the message to be introduced at the femtocell 10-1 (step 304). Again, the rights management process is optional. Note that this rights management process may be performed, or partially performed, prior to generation of the message at the mobile device 12-1 and receipt of the message at the femtocell 10-1. As described above, the rights management process is performed using one or more rights management rules based on factors such as, but not limited to, license fee payment by the user of the mobile device 12-1, location, message introduction frequency, message type, message size, message content type, and/or social network relationships.

If the user of the mobile device 12-1 is not permitted to introduce the message at the femtocell 10-1, the geographic messaging function 22 of the femtocell 10-1 may provide a corresponding response to the mobile device 12-1. However, in this embodiment, the user of the mobile device 12-1 is permitted to introduce the message at the femtocell 10-1. As such, the geographic messaging function 22 of the femtocell 10-1 sends information regarding the message to the central server 44 via the network 46 (step 306). The information regarding the message may be the message itself or any information about the message needed by the message routing function 48 of the central server 44 to identify the femtocells to which the message is to be routed.

Upon receiving the message information, the central server 44, and particularly the message routing function 48, identifies femtocells located within the geographic AOI of the message (step 308). More specifically, the femtocell database 50 preferably stores the locations of the femtocells 10-1 through 10-N. Note that, in one embodiment, the femtocells 10-1 through 10-N report their locations to the central server 44 automatically or upon request. As such, the message routing function 48 queries the femtocell database 50 to determine which of the femtocells 10-1 through 10-N are located within the geographic AOI of the message. As such, the message routing function 48 returns a list of femtocells to which the message is to be routed to the femtocell 10-1 (step 310). The list of femtocells includes information needed by the femtocell 10-1 to send the message directly to the femtocells via the P2P network. For example, the list of femtocells may include peer identifiers (IDs) of the femtocells 10-2 and 10-3 in the P2P network of femtocells. In this example, the femtocells 10-2 and 10-3 are included in the list of femtocells to which the message is to be located. The femtocell 10-1 then sends the message to the femtocells 10-2 and 10-3 (steps 312 and 314). It should be noted that, in some embodiments, the geographic messaging function 22 may modify the message before sending the message to at least some of the identified femtocells 10-2 and 10-3. For example, if the message includes video content, the geographic messaging function 22 may reduce the quality of the video content of the message to be sent to all of the identified femtocells 10-2 and 10-3 to, for example, reduce bandwidth requirements for delivery of the message, adjust the quality of the video content based on the capabilities of the femtocells 10-2 and 10-3, or the like.

From this point, the operation of the system 38 is the same as that described above with respect to FIGS. 3 and 5. Specifically, in this embodiment, upon receiving the message, the femtocell 10-2, and particular the geographic messaging function 22 of the femtocell 10-2, performs a rights management process to determine whether to deliver the message to mobile devices, such as the mobile devices 12-2 and 14-2, located within the coverage area 42-2 of the femtocell 10-2 (step 316). Again, this rights management process is optional. Using the rights management process, the geographic messaging function 22 of the femtocell 10-2 either denies and therefore discards the message or permits the message. In this example, the message is permitted, and as such, the geographic messaging function 22 of the femtocell 10-2 delivers the message to mobile devices 12-2 and 14-2 located within the coverage area 42-2 of the femtocell 10-2 (steps 318 and 320). As described above, the message may be delivered immediately, or at least substantially immediately, upon receipt by the mobile devices 12-2 and 14-2 located within the coverage area 42-2 of the femtocell 10-2 and/or cached at the femtocell 10-2 for subsequent delivery to mobile devices that enter the coverage area 42-2 of the femtocell 10-2. Upon delivery of the message to the mobile devices 12-2 and 14-2, the geographic messaging clients 30 and 34 of the mobile devices 12-2 and 14-2, respectively, notify their users of the message and present the message to their users.

As described above, the femtocell 10-2 may be configured to provide the message to all mobile devices, such as the mobile devices 12-2 and 14-2, located within the coverage area 42-2 of the femtocell 10-2 or only certain mobile devices located within the coverage area 42-2 of the femtocell 10-2. In addition or alternatively, if additional criteria are defined to limit the scope of the message, the femtocell 10-2 applies those criteria when delivering the message.

Like the femtocell 10-2, in this embodiment, the femtocell 10-3, and particularly the geographic messaging function 22 of the femtocell 10-3, performs a rights management process upon receipt of the message (step 322). Again, this rights management process is optional. Assuming that the message is permitted, the geographic messaging function 22 of the femtocell 10-3 sends the message to the mobile devices 12-3 and 14-3 located within the coverage area 42-3 of the femtocell 10-3 (steps 324 and 326). As discussed above, the message may be delivered immediately, or at least substantially immediately, upon receipt by the mobile devices 12-3 and 14-3 located within the coverage area 42-3 of the femtocell 10-3 and/or cached at the femtocell 10-3 for subsequent delivery to mobile devices that enter the coverage area 42-3 of the femtocell 10-3. Also, as discussed above, prior to delivering the message, the geographic messaging function 22 of the femtocell 10-3 considers any additional criteria for the message that narrow the scope of the message.

While not illustrated in FIG. 6, the users of the mobile devices 12-2, 14-2,12-3, and 14-3 that received the message may be enabled to respond to the message. Preferably, such a response message is handled in the same manner as if the response message were any other message introduced at the femtocells 10-2 and 10-3. Alternatively, the response message may be delivered directly to the mobile device 12-1 using traditional messaging. Further, once a user responds to the message, the message may be rescinded such that the message is not subsequently delivered to any other user.

Again, as discussed above, it should be noted that the rights management process performed by the femtocell 10-1 with respect to introduction of the message from the mobile device 12-1 and/or the rights management processes preformed by the femtocells 10-2 and 10-3 with respect to delivery of the message may be at least partially performed by the message routing function 48 of the central server 44. For instance, the message routing function 48, rather than the geographic messaging function 22 of the femtocell 10-1, may determine whether the mobile device 12-1 has the rights to introduce the message at the femtocell 10-1. Any information needed to perform the rights management process may be obtained from appropriate sources and stored in the femtocell database 50 or similar data structure. Similarly, when identifying femtocells to which to send the message, the message routing function 48 of the central server 44 may perform the rights management processes described above with respect to the femtocells 10-2 and 10-3 using rights management rules based on location, message size, message type, message content type, and/or social network relationship. Likewise, when identifying the femtocells to which to send the message, the message routing function may consider additional criteria defined for the message such as, for example, required femtocell attributes.

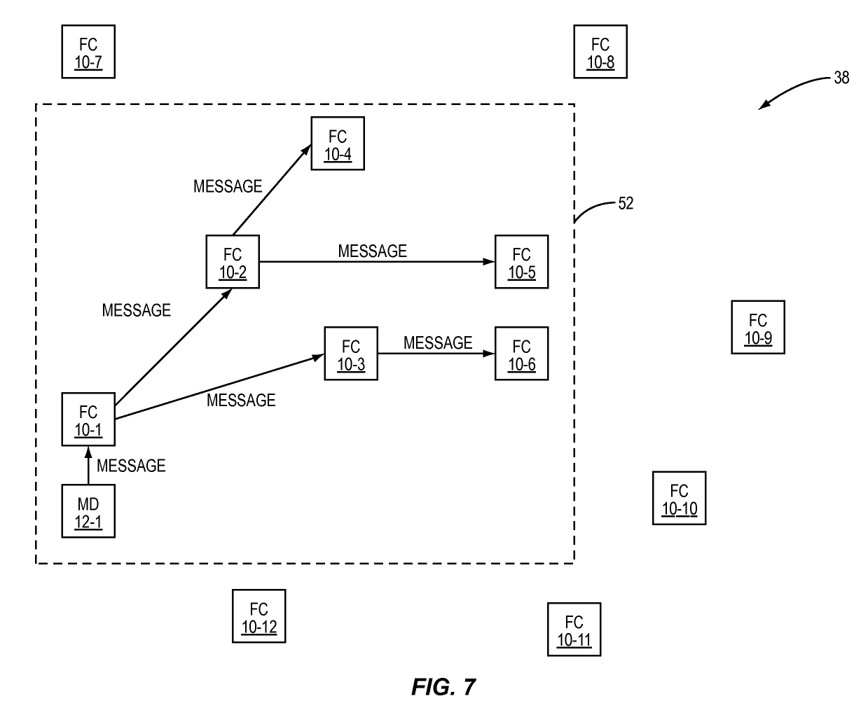

FIG. 7 illustrates the system 38 according to another embodiment of the present disclosure. This embodiment is a pure P2P embodiment wherein messages are routed based on location-based routing tables according to the AOIs of the messages. In this example, a message is introduced by the mobile device 12-1 at the femtocell 10-1. The message has a geographic AOI 52, which includes the femtocells 10-1 through 10-6. Upon receiving the message and, optionally, performing a rights management process as described above, the femtocell 10-1 routes the message based on the geographic AOI 52 of the message and location-based routing tables stored at the femtocell 10-1. In one embodiment, the femtocells 10-1 through 10-N store or otherwise have access to routing tables for each of a number of predefined geographic AOIs. Based on the geographic AOI 52 and the corresponding routing table(s) for the femtocell 10-1 for the geographic AOI 52, the femtocell 10-1, and in particular the geographic messaging function 22, determines that the message is to be routed to femtocells 10-2 and 10-3. As such, the geographic messaging function 22 of the femtocell 10-1 sends the message to the femtocells 10-2 and 10-3.

Likewise, upon receiving the message, the geographic messaging function 22 of the femtocell 10-2 consults the routing tables to determine how to route the message based on the geographic AOI 52 of the message. Note that the geographic AOI 52 of the message may be provided, for example, within the headers of the message. In this example, based on the routing tables, the geographic messaging function 22 of the femtocell 10-2 determines that the message is to be routed to the femtocells 10-4 and 10-5 and, therefore, sends the message to the femtocells 10-4 and 10-5. The geographic messaging functions 22 of the femtocells 10-4 and 10-5 then consult their routing tables based on the geographic AOI 52 of the message and determine that the message does not need to be routed further. As such, propagation of the message ends at the femtocells 10-4 and 10-5.

Similarly, upon receiving the message, the geographic messaging function 22 of the femtocell 10-3 consults its routing tables to determine how to route the message based on the geographic AOI 52 of the message. In this example, the geographic messaging function 22 of the femtocell 10-3 determines that it is to route the message to the femtocell 10-6 and, therefore, routes the message to the femtocell 10-6. The geographic messaging function 22 of the femtocell 10-6 then consults its routing tables based on the geographic AOI 52 of the message and determines that the message does not need to be routed further. As such, propagation of the message ends at the femtocell 10-6. In this manner, the message has been propagated from the femtocell 10-1 to the femtocells 10-2 through 10-6 located within the geographic AOI 52 of the message using corresponding location-based routing tables.

It should be noted that while routing the message, the femtocells 10-1 through 10-6 may perform rights management with respect to propagation. For instance, the rights management may be based on Quality of Service (QoS) such that each femtocell 10-1 through 10-6 may assign higher priority to certain messages based on factors such as, but not limited to, message type, message content type, message size, social network relationships, mobile device or user from which the message originated, or the like. In addition or alternatively, the femtocells 10-1 through 10-6 may modify the message based on QoS or other criteria. For example, if the message includes video content, the femtocells 10-1 through 10-6 may reduce the quality of the video if the message has a priority lower than a predefined threshold priority before propagation and/or delivery of the message.

In addition to propagating the message, since the femtocells 10-1 through 10-6 are located within the geographic AOI 52 of the message, the femtocells 10-1 through 10-6 deliver the message to mobile devices within their coverage areas in the manner described above. As described above, the femtocells 10-1 through 10-6 may perform a rights management process with respect to delivery of the message and deliver the message according to any configurations of the femtocells 10-1 through 10-6 while applying any additional criteria defined for the message.

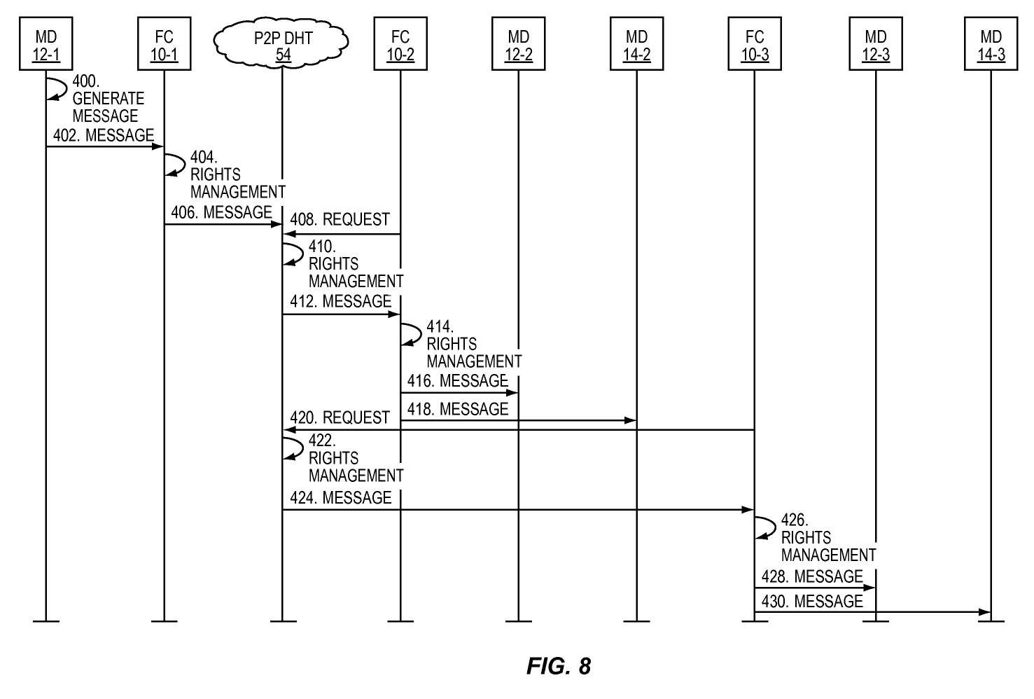

FIG. 8 illustrates the system 38 according to yet another embodiment of the present disclosure. In this embodiment, the femtocells 10-1 through 10-N operate to provide a distributed hash table (DHT) for storing messages based on location. In general, when a message is introduced, one or more hash values, or key values, are generated by applying a hash function to one or more locations corresponding to the geographic AOI of the message. The message is then stored in the DHT using the generated key value(s). Thereafter, the femtocells 10-1 through 10-N obtain messages for their locations by querying the DHT using corresponding key values.

More specifically, in this example, the mobile device 12-1 generates a message having a geographic AOI, as described above (step 400). Once the message is generated, the mobile device 12-1 sends the message to the femtocell 10-1 (step 402). In this embodiment, upon receiving the message, the femtocell 10-1 performs a rights management process to determine whether to permit the message to be introduced at the femtocell 10-1 (step 404). Again, this rights management process is optional and may be performed, or partially performed, prior to generation of the message at the mobile device 12-1 and receipt of the message at the femtocell 10-1. As described above, the rights management process is performed using one or more rights management rules based on factors such as, but not limited to, license fee payment by the user of the mobile device 12-1, location, message introduction frequency, message type, message size, message content type, and/or social network relationships.

If the user of the mobile device 12-1 is not permitted to introduce the message at the femtocell 10-1, the geographic messaging function 22 of the femtocell 10-1 may provide a corresponding response to the mobile device 12-1. However, in this embodiment, the user of the mobile device 12-1 is permitted to introduce the message at the femtocell 10-1. As such, the geographic messaging function 22 of the femtocell 10-1 stores the message in a P2P DHT 54 provided by the femtocells 10-1 through 10-N (step 406). More specifically, in one embodiment, a key value, or hash value, is computed from the geographic AOI using a predetermined hash function, and the message is stored in the P2P DHT 54 in accordance with the computed key value. In another embodiment, the geographic AOI includes one or more locations. For example, the geographic AOI may include one or more predefined geographic areas such as, for instance, one or more zip code areas. Then, for each of the one or more locations, a key value, or hash value, is computed from the location using a predetermined hash function. The message is then stored in the P2P DHT 54 in accordance with the key value(s) for the one or more predefined geographic areas.

At some point thereafter, the femtocell 10-2, and more specifically the geographic messaging function 22 of the femtocell 10-2, sends a request to the P2P DHT 54 for the message (step 408). In one embodiment, the geographic messaging function 22 of the femtocell 10-2 proactively requests any messages for the location of the femtocell 10-2 from the P2P DHT 54 using the key value for the location of the femtocell 10-2. Depending on the particular embodiment, the key value for the location of the femtocell 10-2 may be a key value for the geographic AOI in which the femtocell 10-2 is located or a key value for a predefined geographic area in which the femtocell 10-2 is located. In another embodiment, the femtocell 10-2 is notified by, for example, the femtocell 10-1 that a new message is available in the P2P DHT 54. In response, the geographic messaging function 22 of the femtocell 10-2 requests the message from the P2P DHT 54 using the appropriate key value for the location of the femtocell 10-2.

In this embodiment, upon receiving the request, the femtocell storing the message for the key value for the location of the femtocell 10-2 in the P2P DHT 54 may optionally perform rights management in order to determine whether the femtocell 10-2 is permitted to access the message (step 410). The rights management may be performed using rights management rules based on location, message size, message type, message content type, and/or social network relationship. Likewise, any additional criteria defined for the message such as, for example, required femtocell attributes may also be considered when determining whether the femtocell 10-2 is permitted to access the message. Assuming that the femtocell 10-2 is permitted to access the message, the message is returned to the femtocell 10-2 (step 412).

From this point, the operation of the femtocell 10-2 is the same as that described above with respect to FIGS. 3, 5, and 6. Specifically, in this embodiment, upon receiving the message, the femtocell 10-2, and in particular the geographic messaging function 22 of the femtocell 10-2, performs a rights management process to determine whether to deliver the message to mobile devices, such as the mobile devices 12-2 and 14-2, located within the coverage area 42-2 of the femtocell 10-2 (step 414). Again, the rights management process is optional. Using the rights management process, the geographic messaging function 22 of the femtocell 10-2 either denies and therefore discards the message or permits the message. In this example, the message is permitted, and as such, the geographic messaging function 22 of the femtocell 10-2 delivers the message to mobile devices 12-2 and 14-2 located within the coverage area 42-2 of the femtocell 10-2 (steps 416 and 418). As described above, the message may be delivered immediately, or at least substantially immediately, upon receipt by the mobile devices 12-2 and 14-2 located within the coverage area 42-2 of the femtocell 10-2 and/or cached at the femtocell 10-2 for subsequent delivery to mobile devices that enter the coverage area 42-2 of the femtocell 10-2. Upon delivery of the message to the mobile devices 12-2 and 14-2, the geographic messaging clients 30 and 34 of the mobile devices 12-2 and 14-2, respectively, notify their users of the message and present the message to their users.

As described above, the femtocell 10-2 may be configured to provide the message to all mobile devices, such as the mobile devices 12-2 and 14-2, located within the coverage area 42-2 of the femtocell 10-2 or only certain mobile devices located within the coverage area 42-2 of the femtocell 10-2. In addition or alternatively, if additional criteria are defined to limit the scope of the message, the femtocell 10-2 applies those criteria when delivering the message.

Like the femtocell 10-2, in this embodiment, the femtocell 10-3, and particularly the geographic messaging function 22 of the femtocell 10-3, sends a request for the message to the P2P DHT 54 (step 420). As discussed above, in one embodiment, the geographic messaging function 22 of the femtocell 10-3 proactively requests any messages for the location of the femtocell 10-3 from the P2P DHT 54 using the key value for the location of the femtocell 10-3. Depending on the particular embodiment, the key value for the location of the femtocell 10-3 may be a key value for the geographic AOI in which the femtocell 10-3 is located or a key value for the predefined geographic area in which the femtocell 10-3 is located. In another embodiment, the femtocell 10-3 is notified by, for example, the femtocell 10-1 that a new message is available in the P2P DHT 54. In response, the geographic messaging function 22 of the femtocell 10-3 requests the message from the P2P DHT 54 using the appropriate key value for the location of the femtocell 10-3.

In this embodiment, upon receiving the request, the femtocell storing the message for the key value for the location of the femtocell 10-3 in the P2P DHT 54 may optionally perform rights management in order to determine whether the femtocell 10-3 is permitted to access the message (step 422). The rights management may be performed using rights management rules based on location, message size, message type, message content type, and/or social network relationship. Likewise, any additional criteria defined for the message such as, for example, required femtocell attributes may also be considered when determining whether the femtocell 10-3 is permitted to access the message. Assuming that the femtocell 10-3 is permitted to access the message, the message is returned to the femtocell 10-3 (step 424).

From this point, the operation of the femtocell 10-3 is the same as that described above with respect to FIGS. 3, 5, and 6. Specifically, in this embodiment, upon receiving the message, the femtocell 10-3, and in particular the geographic messaging function 22 of the femtocell 10-3, performs a rights management process upon receipt of the message (step 426). Again, the rights management process is optional. Assuming that the message is permitted, the geographic messaging function 22 of the femtocell 10-3 sends the message to the mobile devices 12-3 and 14-3 located within the coverage area 42-3 of the femtocell 10-3 (steps 428 and 430). As discussed above, the message may be delivered immediately, or at least substantially immediately, upon receipt by the mobile devices 12-3 and 14-3 located within the coverage area 42-3 of the femtocell 10-3 and/or cached at the femtocell 10-3 for subsequent delivery to mobile devices that enter the coverage area 42-3 of the femtocell 10-3. Also, as discussed above, prior to delivering the message, the geographic messaging function 22 of the femtocell 10-3 considers any additional criteria for the message that narrow the scope of the message.

While not illustrated in FIG. 8, the users of the mobile devices 12-2, 14-2,12-3, and 14-3 that received the message may be enabled to respond to the message. Preferably, such a response message is handled in the same manner as if the response message were any other message introduced at the femtocells 10-2 and 10-3. Alternatively, the response message may be delivered directly to the mobile device 12-1 using traditional messaging. Further, once a user responds to the message, the message may be rescinded such that the message is not subsequently delivered to any other user.

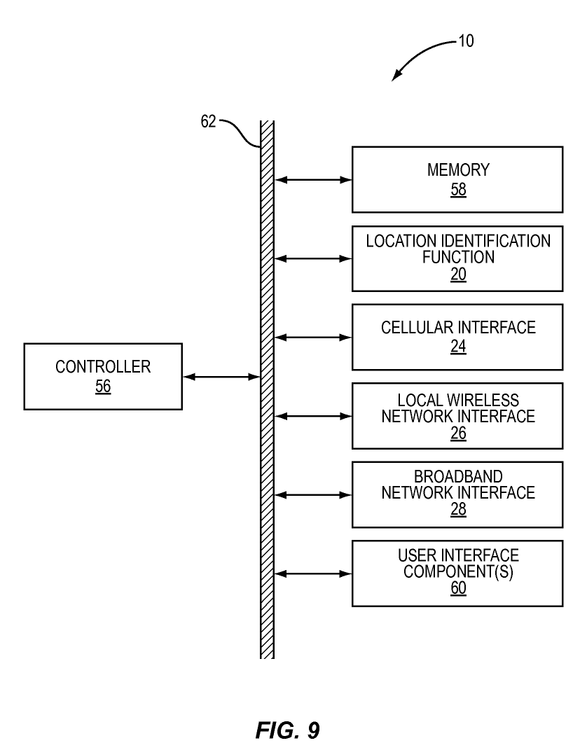

FIG. 9 is a block diagram of the femtocell 10 of FIG. 1 according to one embodiment of the present disclosure. As illustrated, the femtocell 10 includes a controller 56 connected to memory 58, the location identification function 20, the cellular interface 24, the local wireless network interface 26, the broadband network interface 28, and one or more user interface components 60 by a bus 62 or similar mechanism. The controller 56 is a microprocessor, digital Application Specific Integrated Circuit (ASIC), Field Programmable Gate Array (FPGA), or the like. In this embodiment, the controller 56 is a microprocessor, and the geographic messaging function 22 (FIG. 1) is implemented in software and stored in the memory 58 for execution by the controller 56. Further, in this embodiment, the location identification function 20 is implemented in hardware and may be, for example, a GPS receiver. The one or more user interface components 60 may include one or more user input devices such as buttons, one or more user output devices such as a display, or the like.

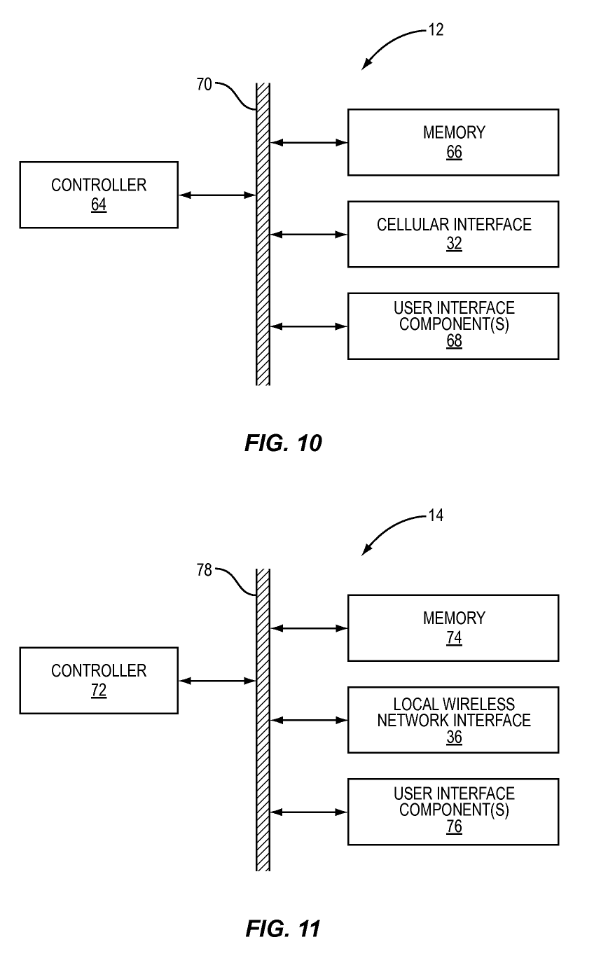

FIG. 10 is a block diagram of the mobile device 12 of FIG. 1 according to one embodiment of the present disclosure. As illustrated, the mobile device 12 includes a controller 64 connected to memory 66, the cellular interface 32, and one or more user interface components 68 by a bus 70 or similar mechanism. The controller 64 is a microprocessor, digital ASIC, FPGA, or the like. In this embodiment, the controller 64 is a microprocessor, and the geographic messaging client 30 (FIG. 1) is implemented in software and stored in the memory 66 for execution by the controller 64. The one or more user interface components 68 include one or more user input devices such as a keypad, one or more user output devices such as a display, one or more combined user input output devices such as a touchscreen, or the like.

FIG. 11 is a block diagram of the mobile device 14 of FIG. 1 according to one embodiment of the present disclosure. As illustrated, the mobile device 14 includes a controller 72 connected to memory 74, the local wireless network interface 36, and one or more user interface components 76 by a bus 78 or similar mechanism. The controller 72 is a microprocessor, digital ASIC, FPGA, or the like. In this embodiment, the controller 72 is a microprocessor, and the geographic messaging client 34 (FIG. 1) is implemented in software and stored in the memory 74 for execution by the controller 72. The one or more user interface components 76 include one or more user input devices such as a keypad, one or more user output devices such as a display, one or more combined user input output devices such as a touchscreen, or the like.

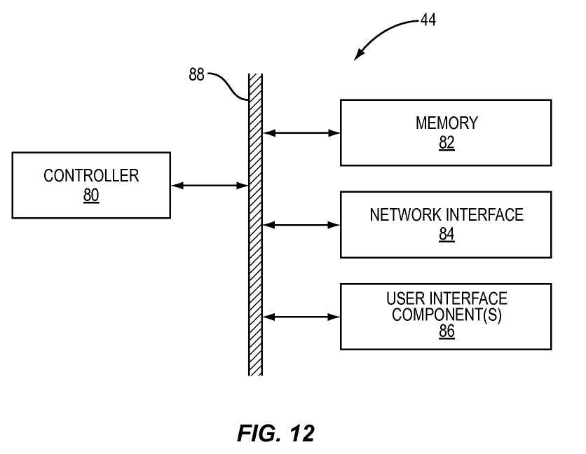

FIG. 12 is a block diagram of the central server 44 of FIG. 4 according to one embodiment of the present disclosure. As illustrated, the central server 44 includes a controller 80 connected to memory 82, a network interface 84, and one or more user interface components 86 by a bus 88 or similar mechanism. The controller 80 is a microprocessor, digital ASIC, FPGA, or the like. In this embodiment, the controller 80 is a microprocessor, and the message routing function 48 (FIG. 4) is implemented in software and stored in the memory 82 for execution by the controller 80. The network interface 84 connects the central server 44 to the network 46 (FIG. 4). The one or more user interface components 86 include one or more user input devices such as a keypad, one or more user output devices such as a display, one or more combined user input output devices such as a touchscreen, or the like.

Those skilled in the art will recognize improvements and modifications to the embodiments of the present invention. All such improvements and modifications are considered within the scope of the concepts disclosed herein and the claims that follow.

What is claimed is:

1. A method of operating an access point of a plurality of access points connected in a peer-to-peer (P2P) network comprising:
receiving a message having a geographic area of interest (AOI) from a mobile device within a coverage area of the access point;
propagating the message to one or more access points located in the geographic AOI of the message via the P2P network for delivery to devices of users located within the geographic AOI of the message.

2. The method of claim 1 wherein the geographic AOI of the message is manually defined by a user of the mobile device.

3. The method of claim 2 wherein the geographic AOI of the message is manually selected by the user from a plurality of predefined geographic AOIs.

4. The method of claim 2 wherein the geographic AOI is arbitrarily selected by the user of the mobile device.

5. The method of claim 1 wherein geographic AOIs are predefined for a plurality of message types, and the geographic AOI of the message is a predefined geographic AOI for a message type of the message.

6. The method of claim 1 further comprising:
determining whether the message from the mobile device is permitted to be introduced at the access point;
wherein propagating the message comprises propagating the message to the one or more access points located in the geographic AOI of the message if the message is permitted to be introduced at the access point.

7. The method of claim 6 wherein determining whether the message from the mobile device is permitted to be introduced at the access point comprises performing rights management using one or more rules based on one or more factors selected from a group consisting of: whether a license fee has been paid by a user of the mobile device, location, message introduction frequency, message type, message size, message content type, and social network relationship.

8. The method of claim 1 wherein propagating the message comprises sending the message to a central server, wherein the central server identifies the one or more access points located in the geographic AOI of the message and sends the message to the one or more access points located in the geographic AOI of the message.

9. The method of claim 1 wherein propagating the message comprises:
sending a request for the one or more access points located in the geographic AOI of the message to a central server;
receiving information identifying the one or more access points located in the geographic AOI of the message from the central server in response to the request; and
sending the message to the one or more access points located in the geographic AOI of the message using the information identifying the one or more access points located in the geographic AOI of the message received from the central server.

10. The method of claim 1 wherein propagating the message comprises propagating the message to one or more other access points of the plurality of access points connected in the P2P network according to location-based routing tables.

11. The method of claim 1 wherein propagating the message comprises:
generating at least one key value from the geographic AOI of the message using a predetermined hash function for a P2P Distributed Hash Table (DHT) implemented using the plurality of access points; and
storing the message in the P2P DHT according to the at least one key value;
wherein the message is subsequently obtained from the P2P DHT by the one or more access points located in the geographic AOI of the message using the at least one key value.

12. The method of claim 1 further comprising:
receiving a second message having a second geographic AOI originating from a second access point of the plurality of access points connected in the P2P network; and
delivering the second message to one or more mobile devices located within the coverage area of the access point.

13. The method of claim 12 further comprising:
determining whether the second message is permitted to be delivered to the one or more mobile devices;
wherein delivering the second message to the one or more mobile devices within the coverage area of the access point if the second message is permitted to be delivered to the one or more mobile devices.

14. The method of claim 13 wherein determining whether the second message is permitted to be delivered to the one or more mobile devices within the coverage area of the access point comprises performing rights management using one or more rules based on one or more factors selected from a group consisting of: whether a license fee has been paid by users of the one or more mobile devices, location, message introduction frequency, message type, message size, message content type, and social network relationship.

15. The method of claim 12 wherein delivering the second message to the one or more mobile devices within the coverage area of the access point comprises delivering the second message to the one or more mobile devices if the access point is within the second geographic AOI of the second message.

16. The method of claim 12 wherein receiving the second message comprises receiving the second message from a central server associated with the P2P network, wherein the central server received the second message from the second access point, identified the access point as being located in the second geographic AOI of the second message, and sent the second message to the access point.

17. The method of claim 12 wherein receiving the second message comprises receiving the second message from the second access point under control of a central server associated with the P2P network that identifies the access point as being located in the second geographic AOI of the second message.

18. The method of claim 12 wherein receiving the second message comprises receiving the second message as a result of the second message being routed through the P2P network using location-based routing tables.

19. The method of claim 18 further comprising routing the second message to one or more additional access points from the plurality of access points based on the location-based routing tables of the access point.

20. The method of claim 19 wherein one or more Quality of Service (QoS) factors are utilized to prioritize the second message when routing the second message to the one or more additional access points.

21. The method of claim 12 wherein the plurality of access points implement a P2P Distributed Hash Table (DHT) for storing messages in association with key values generated based on location, and receiving the second message comprises:
sending a query to the P2P DHT with a key value corresponding to a location of the access point; and
receiving the second message in response to the query.

22. The method of claim 12 wherein delivering the second message comprises delivering the second message to all mobile devices located within the coverage area of the access point.

23. The method of claim 12 wherein delivering the second message comprises delivering the second message to one or more mobile devices located within the coverage area of the access point that satisfy one or more predefined criteria.

24. The method of claim 12 wherein the second message is valid for a defined time period, and delivering the second message comprises:
storing the second message at the access point; and
delivering the second message to the one or more mobile devices located within the coverage area of the access point during the time period in which the second message is valid.

25. The method of claim 1 wherein a time period is defined for the message such that the message is to be delivered to devices of users located in the geographic AOI of the message during the time period.

26. The method of claim 1 wherein one or more additional criteria are defined for the message that further narrow a scope of the message.

27. The method of claim 1 wherein the plurality of access points are femtocells.

28. An access point of a plurality of access points connected in a peer-to-peer (P2P) network, comprising:
a first interface communicatively coupling the access point to one or more mobile devices located within a coverage area of the access point;
a second interface connecting the access point to a broadband network over which the P2P network connecting the plurality of access points is formed; and
a controller associated with the first and second interfaces and adapted to:
receive a message having a geographic area of interest (AOI) from a mobile device within the coverage area of the access point; and
propagate the message to one or more access points located in the geographic AOI of the message via the P2P network for delivery to devices of users located within the geographic AOI of the message.

29. A computer readable medium comprising software for instructing a controller of an access point of a plurality of access points connected in a peer-to-peer (P2P) network to:
receive a message having a geographic area of interest (AOI) from a mobile device within a coverage area of the access point; and
propagate the message to one or more access points located in the geographic AOI of the message via the P2P network for delivery to devices of users located within the geographic AOI of the message.
